(19) United States
(12) Patent Application Publication
(10) Pub. No.: US 2019/0093992 A1
(43) Pub. Date: Mar. 28, 2019

(54) DUAL SIDE DOORS VEHICLE FOR PROTECTING SOLDIERS FROM MULTIPLE DIRECTIONS ATTACK

(71) Applicant: YUEJIE ZHANG, FRANKFORT, IL (US)

(72) Inventor: YUEJIE ZHANG, FRANKFORT, IL (US)

(21) Appl. No.: 15/719,486

(22) Filed: Sep. 28, 2017

(51) Int. Cl. F41H 5/22; B60J 5/04; F41H 7/02

(52) U.S. Cl. CPC F41H 5/226; F41H 7/02; B60J 5/0486; B60J 5/047

(57) ABSTRACT

The double side doors armored vehicle combines hinged side door with a foldable top screen and a foldable bottom panel, overlaid by a gullwing door in a vehicle body together in a specific arrangement to form a half-closed space for providing multiple direction shields to soldier and police when all of doors and panels are opened. The opening gullwing doors can protect attacks from high building. The opening swing doors can protect from front, right, and left. The standing up top screens and unfold bottom panels extend protection to soldier's head and legs. The vehicle provides multiple directions protection as a mobile shield that is stronger than personal protection devices. It can be a man driven car or an autonomous vehicle. It can be used as leading vehicle, or used in group for protecting marching soldiers. It can be a checking post, a block, an information collecting center.

### CLAIM OF PRIORITY

This application claims priority of U.S. Provisional Patent Application 62/409,310 entitled A DUAL SIDE DOORS VEHICLE FOR PROTECTING SOLDIERS FROM MULTIPLE DIRECTIONS ATTACK, filed Oct. 17, 2016, the teaching of which are incorporated herein by reference.

### FIELD OF THE INVENTION

The present invention related to armored vehicle with dual side doors for protecting soldiers or policemen from attacks of multiple directions during implementing multiple tasks of patrol, surveillance, support, rescue, observation post, guard, checking point, and fight.

### BACKGROUND OF THE INVENTION

Terror threat looms across the world, an Anti-terrorism system should be reinforced day by day. The scope for Anti-terrorism systems is very large in physical terms (long borders, vast areas, high traffic volumes in busy cities, etc.). In this environment, the development of a persistent Anti-terrorism protection system is a difficult task. Such a system should bring together diverse state-of-the-art technologies to enable persistent intelligence, surveillance and reconnaissance missions, and enable potential actions. Designing such a system-of-systems comprises a major technological project. A particular design problem for this system is that it will face many uncertainties in the future. The threat of terrorism may increase, decrease or remain the same, the type of terrorism and location are difficult to predict, and there are technological uncertainties. Yet we want to design a terrorism system conceived and designed today in order to prevent acts of terrorism for a decade or more. A potential solution is to incorporate flexibility into system design for the reason that the flexibility embedded can be exercised in future as uncertainty unfolds and updated information arrives. And the design and valuation of a protection system should not be based on a single scenario, but an array of scenarios. Flexibility can be incorporated in the design of the terrorism system in the form of options that can be exercised in the future when new information is available. will create a flexible Anti-terrorism system that is able to cope with new requirements that may arise. Military action can take over a city in short time, it is a long way to keep safety. 24 hours and 7 days patrolling is an important tactical operation to control a dangerous area. Soldiers and policemen stand up in front line. By present a robot, robotic vehicle, or autonomous driving car are more focus on specific task or civil transportation, they are not intend to be used as a bullet resist equipment for soldiers. Because terrorists are using assault weapons, personal protection equipment can't meet this challenge, there is a need to develop a new stronger mobile shield for protecting soldiers and policemen in street. This new mobile shield should provide better protection than personal protection equipment significantly.

There are many different armored fighting vehicles for military and police, they are good for protecting soldiers or policemen inside the vehicle and allow to return fires from inside of armored vehicle, but they are not designed to use as a multiple directions protecting equipment for soldiers or policemen walking around the vehicle. When soldiers and policemen are in vehicle, the vehicle provides a complete protection because the body and doors of vehicle are forming a close system. After a soldier or a policeman jump out of the vehicle, the body of vehicle only can provide one direction shield naturally, soldier or policeman exposure to attack from 5 other directions. Soldiers or police have to depend on their personal protection equipment or movement. The personnel protection equipment of body armor vet and helmet only provide limit light protection partly because human being's capability limits the weight and volume of personal protection equipment. Soldier and policemen are easy wound in dangerous environments.

Although there are many powerful firearms and armored vehicles, soldiers and policemen have to walk on street for fighting against enemy and crime, they face attack from six directions: front, right, left, top, bottom, and back. Soldier can walk between the armored vehicle, follow the vehicle, and stand on the side of the armored vehicle. The armored vehicle provides one or two direction protection, but also affect soldier watching and firing back in such directions.

By present there is no vehicle designed for providing a full mobile shield for protecting soldier and policemen who fight on ground, there is a gap between fighting vehicle and soldier, they can't move, protect, and fight together. Because an armored vehicle must have a high ground clearance for easy pass through, there is a big gap between an opening hinged side door and ground. This gap reduces the shield function of the opened door dramatically. The hinged side doors of normal policeman are too short and narrow, the opening doors can't provide full body cover, police are shot from front, side, and high building. A normal opening side door of the vehicle can't allow soldier stand up safely and easily for watching and firing, soldier have to bend in uncomfortable situation that affect soldier do their best. Soldier have to expose their head and body bravely and dangerously for taking better observation position and efficient shooting angle, soldier's head and legs become easy target in battle field.

By studying shooting angel and vehicle structure carefully, an opening gullwing door is good for protecting attack from high building but no protection for side, an opening hinged swing side door is a device for protecting attacks from front and side, but no protection for top. To install a gullwing door and a special hinged swing door in the same side of a vehicle is designed for forming a protected space for soldier or policemen in fighting ground. Our invention combines a hinged right side door with a foldable top screen and a bottom panel, a right gullwing door, a hinged left side door with a foldable top screen and a bottom panel, a left gullwing door, and a vehicle body together in a specific arrangement to create a new double side doors armored vehicle for providing multiple direction shields to soldier and police.

The driver opens the gullwing door upward, opens the hinged swing side door outward in the same side of the vehicle, and then enter the vehicle. The driver closes the hinged swing door with folded top screen and bottom panel first, and then closes the gullwing door. The closed gullwing overlays on outside of the closed hinged swing side door. The overlaid gullwing door and swing side door reinforces side protection significantly.

The driver slows down the vehicle before start a ground battel. The gullwing door is opened upward, and then the hinged swing side door is opened outward. Soldiers get off the vehicle, stand up under the opened gullwing door and behind the opened side door. An opening right and left gullwing doors can protecting attacks from high building. An opening right and left hinged swing doors can protecting attacks from front, right, and left acceptably after the top folded screens and the folded bottom panels are unfolded. The standing up top screens can protect soldier's head and allow soldier stand up for better watching and fighting. The unfold bottom panels reduce shooting angle significantly and provide protection to soldier's legs and feet.

The dual side doors armored vehicle has capability to provide multiple directions protection as a mobile shield that is stronger than personal protection devices. The dual side doors armored can be a man driven car or an autonomous vehicle. It can be used as leading vehicle before other vehicle, or used in group for protecting marching soldiers. It can be used a checking post, street block, a shelter, an information collecting center etc. These side doors can be made of armored material such as alloy steel, fibers, aluminum, glass etc. Although the vehicle body that included all operation system, control system, information system, firearm system is most important, they are shown as external elements in our invention

The design of double side doors armored vehicle creates a platform for man drive vehicle or self-driving vehicle. The bullet-resistant material will be used to build the swing door, gullwing door, folding screen, folding panel, and vehicle body. The unique dual side door vehicle is specifically designed with the objective of protecting passengers and walking soldier in high-threat environments in any conditions. Wherever it will find itself in, the unique double side doors armored vehicle has the capability to provide the kind of reliability, mobility, and protection that transport vehicles like this are unknown for. The double side doors vehicle can be used for army, marine, national guard, police, SWAT, security agency for patrol, fighting etc. It will be useful in riot control if other equipment is installed such as a water canon, a flashing light etc.

Any prior arts of armored vehicle haven't a hinged swing door with foldable panels overlapped with a sea gullwing door for providing full protection capability of inside and outside the vehicle to the passenger in purpose.

In conclusion, insofar as I am aware, no armored vehicle, police car formerly developed provides the dual side doors as a mobile shield to soldiers comfortably riding, following, and fighting around the vehicle.

### SUMMARY

Our invention combines a right hinged side door with foldable top screen and bottom panel, a right gullwing door, a left hinged side door with foldable top scree and bottom panel, a left gullwing door and a vehicle body together in a specific arrangement to create a new double side doors armored vehicle for providing multiple direction shields to soldier and police. An opening right and left gullwing doors can protecting attacks from high building process. An opening right and left hinged swing doors can protecting attacks from front, right, and left. The standing up top screens and unfold bottom panels extend protection to soldier's head and legs. The dual side doors armored vehicle capability to provide multiple directions protection as a mobile shield that is stronger than personal protection devices. The dual side doors armored can be a man driven car or an autonomous vehicle. It can be used as leading vehicle before other vehicle, or used in group for protecting marching soldiers. It can be used a checking post, street block, a shelter, an information collecting center etc. These side doors can be made of armored material such as alloy steel, fibers, aluminum, glass etc. Although the vehicle body that included all operation system, control system, information system, firearm system is most important, they are shown as external elements in our invention. We make a few special arrangements in our invention as below:

a). A gullwing door hinged on the top frame of the vehicle body, a close gullwing door reinforces side protection, an opening gullwing door provides a top protection.

b). A swing side door with top folding screen and bottom panel hinged on the front of the vehicle body, a close swing side door provides a basic side protection, an opening swing side door with unfold top screen and bottom panel provides a full front protection and most of side protection. The heights and widths of the swing door, top screen, and bottom panel can be adjusted according to design.

c). The combination of swing doors and gullwing doors overlap each other in both sides in closing position, it not only provides dual side protection but also prevent broking into the vehicle.

d). The opening of swing doors and gullwing doors creates a protected space where soldier can walk along with the vehicle and doing tasks safely.

All of parts forms a close system that act as a mobile shield for protecting soldier and police.

### DRAWINGS

FIG. 1 is a right side view of the dual side doors vehicle without opening doors.

FIG. 2 is a right-front view of the dual side doors vehicle without opening doors.

FIG. 3 is a top view of the dual side doors vehicle with opening all of side doors.

FIG. 4 is a right side view of the dual side doors vehicle with opening all of side doors.

FIG. 5 is a front view of the dual side doors vehicle with opening all of side doors.

FIG. 6 is a right view of the dual side doors vehicle with opening of right gullwing door.

FIG. 7 is a right-rear view of the dual side doors vehicle with opening of right gullwing door, right hinged side door, right top folding screen, and bottom folding panel.

FIG. 8 is a top view of the dual side doors vehicle with opening of right gullwing door and right hinged side door.

FIG. 9 is a front view of the dual side doors vehicle with opening of right gullwing door and right hinged side door.

FIG. 10 is a top view of the right gullwing door.

FIG. 11 is a perspective view of the right gullwing door.

FIG. 12 is a front view of the right gullwing door.

FIG. 13 is a right view of the right gullwing door.

FIG. 14 is a side view of the folded right hinged side door

FIG. 15 is a front view of the folded right hinged side door

FIG. 16 is a side view of the opening right hinged side door

FIG. 17 is a front-right view of the opening right hinged side door

FIG. 18 is a front view of the gullwing door

FIG. 19 is a side view of the gullwing door

FIG. 20 is a perspective view of half opened left hinged side door

FIG. 21 is a perspective view of full opened left hinged side door

### DETAILED DESCRIPTION

FIG. 1 is a right view of the dual side doors vehicle comprises Vehicle Body 10, Right Gullwing Door 20, Right Hinged Side Door 30, Left Gullwing Door 40, and Left Hinged Side Door 50 in all of closed situation. The gullwing door overlays on the swing side door in each side that reinforce the side protection because there are multiple layers of armored material. The feature of double side doors provides a strong shield for passengers. The side doors are made of armored material such as alloy steel, glass, fibers, aluminum etc.

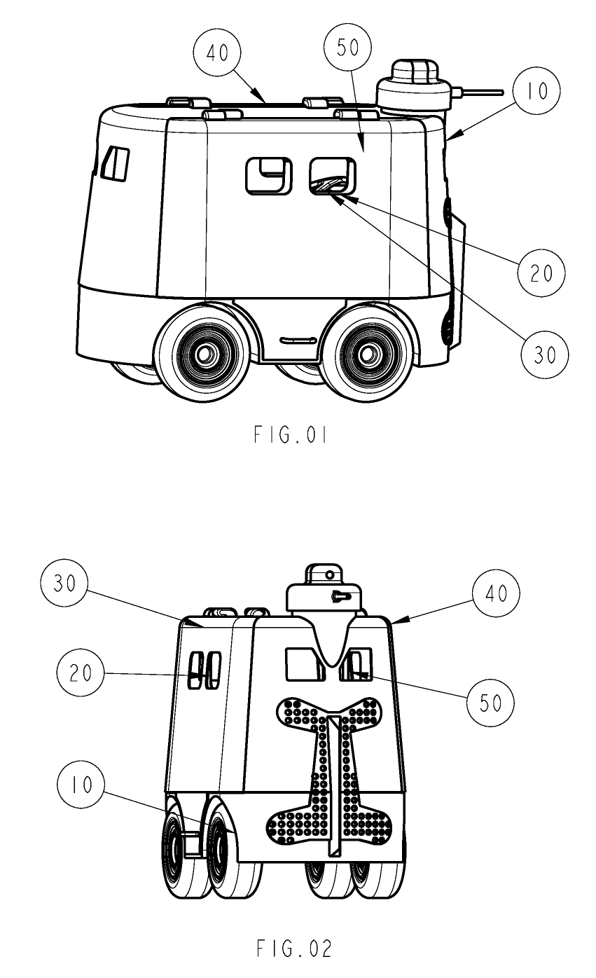

FIG. 2 is perspective view of the dual side doors vehicle comprises Vehicle Body 10, Right Gullwing Door 20, Right Hinged Side Door 30, Left Gullwing Door 40, and Left Hinged Side Door 50 in all of closed situation.

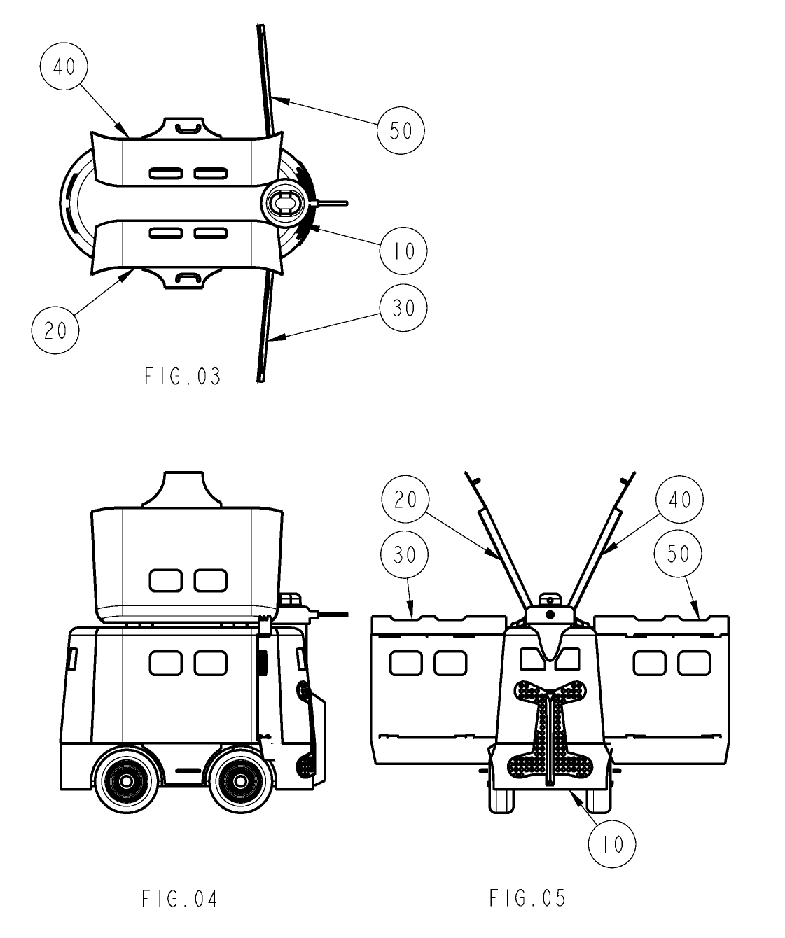

FIG. 3 is a top view of the dual side doors vehicle comprises Vehicle Body 10, Right Gullwing Door 20, Right Hinged Side Door 30, Left Gullwing Door 40, and Left Hinged Side Door 50 in all of opened situation. Soldiers can stand up under the opened gullwing doors and behind opened swing side doors.

FIG. 4 is a side view of the dual side doors vehicle in a full opening situation. Soldiers can stand up under the opened gullwing doors and behind opened swing side doors.

FIG. 5 is a front view of the dual side doors vehicle comprises Vehicle Body 10, Right Gullwing Door 20, Right Hinged Side Door 30, Left Gullwing Door 40, and Left Hinged Side Door 50 in all of opened situation. Soldiers can stand up under the opened gullwing doors and behind opened swing side doors.

FIG. 6 is a right side view of the dual side doors vehicle comprises Vehicle Body 10, Right Gullwing Door 20, Right Hinged Side Door 30, Left Gullwing Door 40, and Left Hinged Side Door 50. The right gullwing door 20 is opened upward, and other doors keep in close.

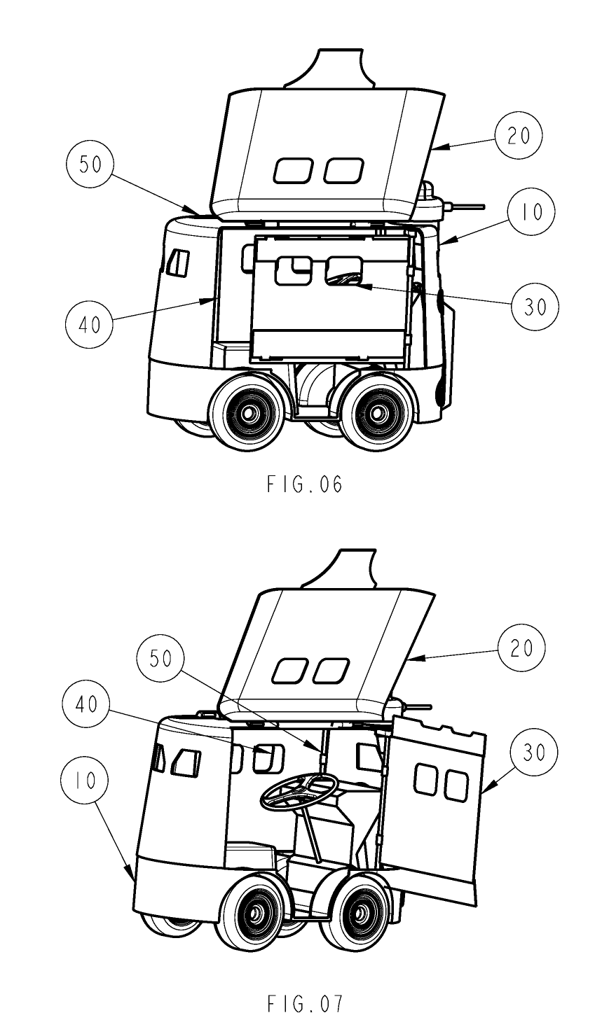

FIG. 7 is a right side view of the dual side doors vehicle comprises Vehicle Body 10, Right Gullwing Door 20, Right Hinged Side Door 30, Left Gullwing Door 40, and Left Hinged Side Door 50. The right gullwing door 20 is opened upward, the right hinged side door 30 with unfold top screen 32 and bottom panel 33 is opened. All of left side doors is closed.

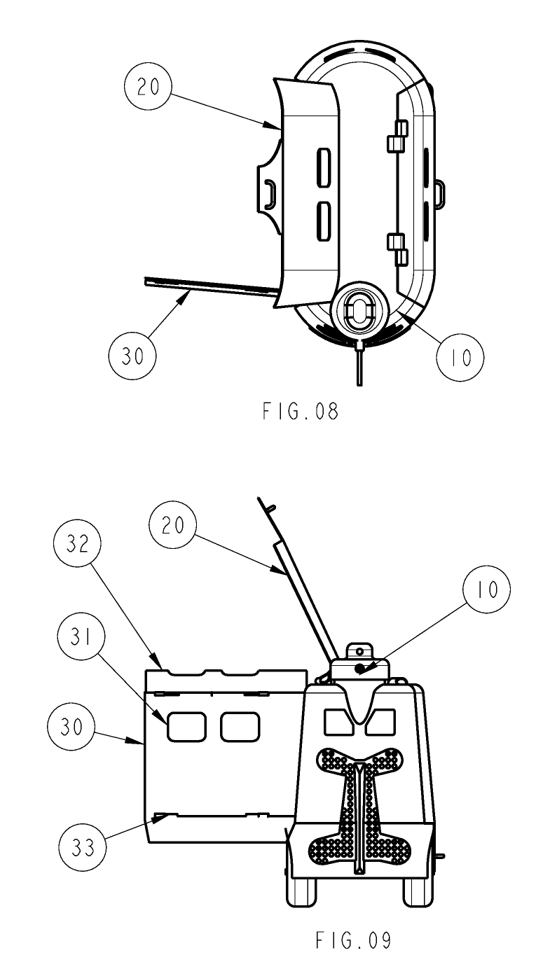

FIG. 8 is a top view of the dual side doors vehicle. The right gullwing door 20 is opened upward, the right hinged side door 30 is opened.

FIG. 9 is a front view of the dual side doors vehicle comprises Vehicle Body 10, Right Gullwing Door 20, Right Hinged Side Door 30 that included Right Hinged Side Door Body 31, Right Top Folding Screen 32, Right Bottom Folding Panel 33. The right gullwing door 20 is opened upward. The right hinged side door 30 with unfold top screen 32 and bottom panel 33 is opened. All of left side doors is closed.

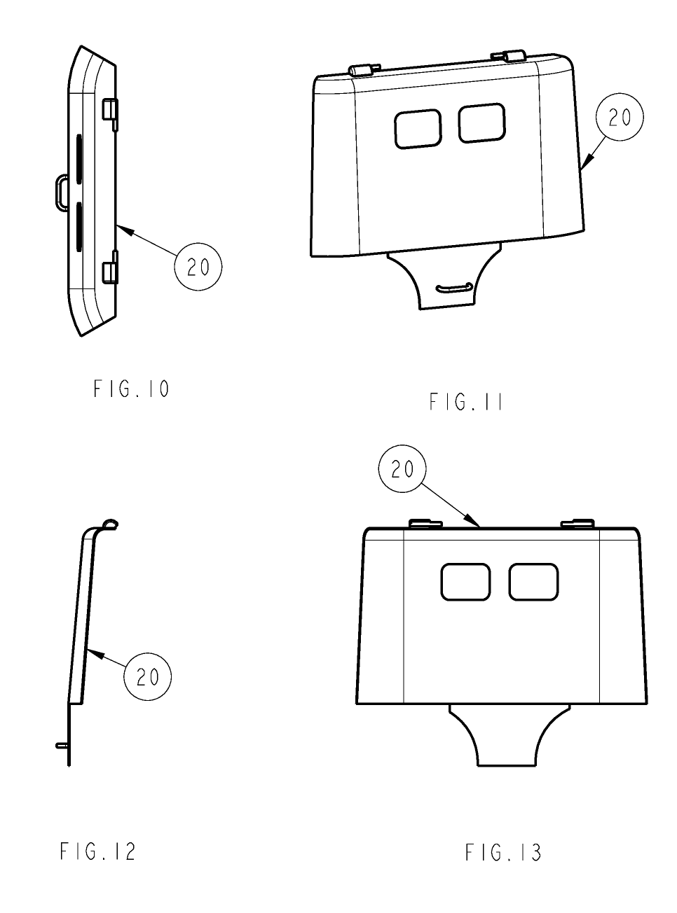

FIG. 10 is a top view of the right gullwing door 20 in closed position.

FIG. 11 is a perspective view of the right gullwing door 20 in closed situation

FIG. 12 is a front view of the right gullwing door 20 in closed position.

FIG. 13 is a right side view of the right gullwing door 20 in closed position.

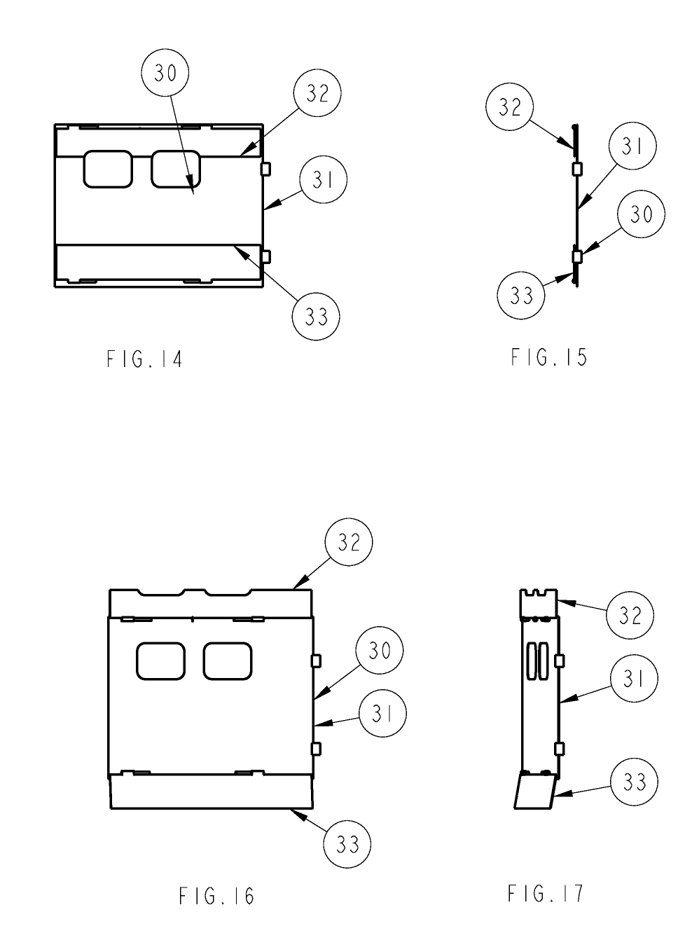

FIG. 14 is a side view of the right hinged swing door 30 comprises Right Hinged Side Door Body 31, Right Top Folding Screen 32, Right Bottom Folding Panel 33. The right top screen 32 is folded. The right bottom panel 33 is folded.

FIG. 15 is a front view of the right hinged swing door 30 comprises Right Hinged Side Door Body 31, Right Top Folding Screen 32, Right Bottom Folding Panel 33. The right top screen 32 is folded. The right bottom panel 33 is folded.

FIG. 16 is a side view of the right hinged swing door 30 comprises Right Hinged Side Door Body 31, Right Top Folding Screen 32, Right Bottom Folding Panel 33. The right top screen 32 is standing up. The right bottom panel 33 is unfold.

FIG. 17 is a perspective view of the right hinged swing door 30 comprises Right Hinged Side Door Body 31, Right Top Folding Screen 32, Right Bottom Folding Panel 33. The right top screen 32 is standing up. The right bottom panel 33 is unfold.

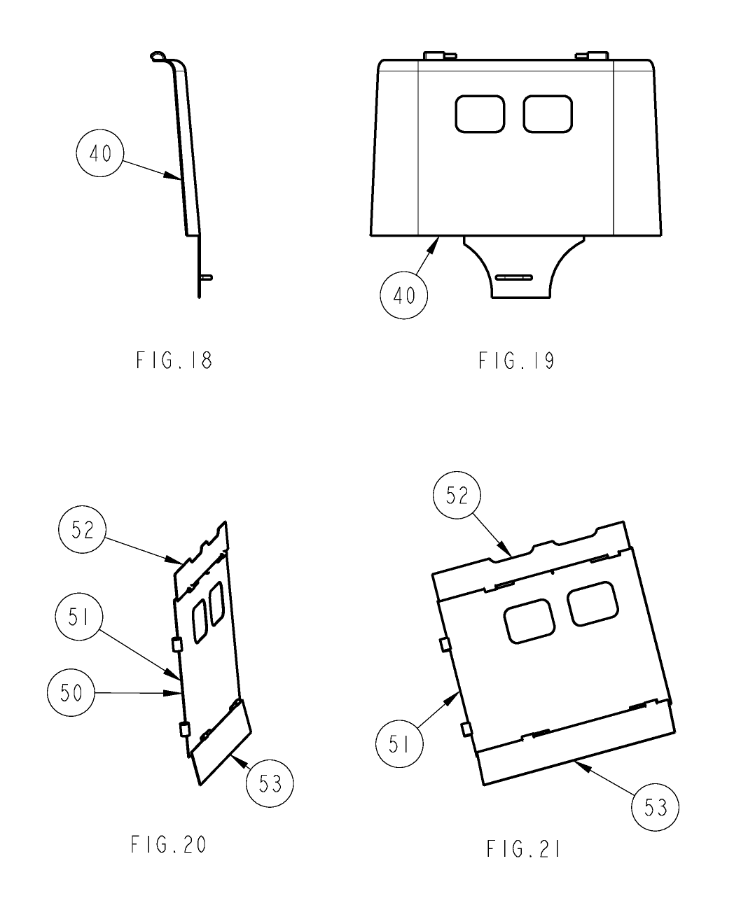

FIG. 18 is a front view of the left gullwing door 40 in close position.

FIG. 19 is a side view of the left gullwing door 40 in close position.

FIG. 20 is a perspective view of the left hinged swing door 50 comprises Left Hinged Side Door Body 51, Left Top Folding Screen 52, Left Bottom Folding Panel 53. The left top screen 52 is standing up. The left bottom panel 53 is unfold.

FIG. 21 is a perspective view of the left hinged swing door 50 comprises Left Hinged Side Door Body 51, Left Top Folding Screen 52, Left Bottom Folding Panel 53. The left top screen 52 is standing up. The left bottom panel 53 is unfold.

### REFERENCE NUMBER

10 Vehicle Body

20 Right Gullwing Door
30 Right Hinged Side Door
31 Right Hinged Side Door Body
32 Right Top Folding Screen

33 Right Bottom Folding Panel

40 Left Gullwing Door

50 Left Hinged Side Door
51 Left Hinged Side Door Body
52 Left Top Folding Screen
53 Left Bottom Folding Panel

### OPERATION

All of the side doors of the vehicle are closed during normal driving, the right gullwing door can be opened fully and then the right hinged side door can be opened after the vehicle slow down or stop if the driver and passenger want to get off the vehicle from right side. If the riders want to get out the vehicle from left side, they must open the left gullwing door first, and then open the left hinged side door. The riders can open both right and left gullwing doors first, and then open both right and left hinged side doors. The top folding screen will stand up and bottom folding panel will drop down along with the opening of the hinged side door.

(1) To slow down or stop the vehicle

(2) To decide which side doors should be open

(3) To open the gullwing door as a top shield

(4) To open the hinged side door, the top folding screen and bottom folding panel will open automatically as a side shield

(5) Soldier get out the vehicle, stand and walk under the cover of gullwing door and behind the hinged side door

(6) Soldier watch and fire under the cover of the gullwing door and the side door.

(7) Soldier come back inside of the vehicle.

(8) Soldier close the hinged swing door.

(9) Soldier close the gullwing door.

(10) Soldier drive the vehicle with all of side doors closed.

1. A dual side doors vehicle, comprising:
A right hinged side door with a foldable top screen and a foldable bottom panel, overlaid by a right gullwing door, and
A left hinged side door with a foldable top scree and a foldable bottom panel, overlaid by a left gullwing door
and a vehicle body together to create a half closed space for providing multiple direction shields to soldier and police when all of doors are opened.
